(19) United States
(12) Patent Application Publication
(10) Pub. No.: US 2016/0373725 A1
(43) Pub. Date: Dec. 22, 2016

(54) Mobile device with 4 cameras to take 360°x360° stereoscopic images and videos

(71) Applicant: Francisco Pastor, Valdepielagos (ES)

(72) Inventor: Francisco Pastor, Valdepielagos (ES)

(21) Appl. No.: 14/744,049

(22) Filed: Jun. 19, 2015

(51) Int. Cl. H04N 13/02; G06T 3/40; G09G 3/36; H04N 5/232

(52) U.S. Cl. CPC H04N 13/0242; H04N 13/0296; H04N 5/23293; G06T 3/4038; G09G 3/36; H04N 2013/0088

(57) ABSTRACT

A MOBILE DEVICE WITH 4 CAMERAS TO TAKE 360°×360° STEREOSCOPIC IMAGES AND VIDEOS particularly referred to portable videotelephones able to make and reproduce 360°×360° stereoscopic images and videos, comprising two photo/video cameras (3) and (4) fitted on the front (1) of the mobile device on the same horizontal plane, and two photo/video cameras (5) and (6) fitted on the rear (2) of the mobile device on the same horizontal plane.

Said cameras (3), (4), (5) and (6) are each fitted with integrated lenses with an angular vision of 180°×180° or more, the separation between the visual axes of both front and rear cameras being between 0.5 mm and 1 mm.

Cameras (3) and (6) are connected to a synchronised recording and 360×360 image creation interface (7).

### OBJECT OF THE INVENTION

This invention refers in general to mobile communications terminals, more specifically although not exclusively to portable videotelephones able to make and reproduce stereoscopic 360°×360° images and videos using two front and two rear cameras located on the two faces of the device.

Such devices make it possible to receive and transmit information in mobile telecommunications systems such as cellular radiocommunication networks.

Said devices may be referred to as mobile video-telephones.

### PRIOR ART

A number of documents have proposed the inclusion of a video camera and a visualisation device in a mobile telephone apparatus, to permit among other things mobile videoconferencing.

Document U.S. Pat No. 5,414,444 (AT&T) describes a communication device with a cover that can be opened and which contains an LCD type visualisation device and a video camera. According to this document, the video camera can be reoriented when the cover is open, and the communication device incorporates an interactive mechanical element with the cover closed to restart the camera at a standard setting after use.

The PCT number WO97/26744 publication proposes another form of mobile videotelephone, describing a portable telephone with a visualisation device and a camera which are fitted on the main body of the telephone. The camera is fitted on a rotating pivot making it possible to receive images from several directions.

Patent application DE 19528424 describes a mobile communications device that includes a removable computer module consisting of two pivoting moving parts, enabling the module to be opened. The module includes a camera and a first visualisation device assembled on one of the parts, and a second visualisation device fitted the other visualisation device so that, if the module opened, the user can see both visualisation devices.

This invention aims not just to improve the construction and the functionality of mobile terminals but also to give them a new functionality, non-existent until now.

According to one aspect of this invention, a mobile videotelephone is provided which consists of two cameras on the front and another two at the rear, with their visualisation axes at distance of between 0.5 and 1 cm.

With this arrangement, it is possible to make 360°×360° videos stereoscopically.

### DESCRIPTION OF THE INVENTION

The invention refers to portable videotelephones able to make and reproduce stereoscopic 360°×360° images and videos, using two front and two back cameras located on each of the faces of the device.

These devices make it possible to receive and transmit information in mobile telecommunications systems such as radiocommunications cellular networks.

Three-dimensional perception is basically created by the brain thanks to the fact that each eye collects different information on a single reality, and it is precisely this difference which the brain is able to interpret and analyse to create a sensation of volume of objects or a scene captured the human visual system.

There are many different techniques to ensure that each image reaches the eye which corresponds to it.

Elements of both monocular vision and of binocular vision are involved in the creation of these spatial sensations.

These features are enhanced artificially to be able to “recreate” the so-called third dimension.

This can be done using a stereoscope consisting of two mirrors for each eye so that the images are not seen in inverted form, and which have an adjustment depending on the distance and size of the images.

There are also three other main techniques to be able to simulate the stereoscopic (3D) effect: the anaglyph method, the Chromatek system and the Pulfrich effect.

Other interfaces can be included to enhance the unit's flexibility, for example an RS232 interface 58 to transmit and receive data in RS232 format.

The RS232 interface makes it possible for the processor 36 to connect through the busbar 42 to connect other compatible devices to the videotelephone, using a standard RS232 cable.

Depending on the frequency of the updating used and the number of of pixels employed in the images, the transmitted video image data received by the videotelephone may have to be compressed for their transfer via low-data-speed radiocommunication channel such as those at present available in known radiocommunication cellular networks.

Video data can be compressed using the MPEG-4 standard. As an alternative, video images captured can be compressed in some other appropriate format, to transmit the data obtained through the mobile communications system.

It must understood that the forms of implementation described above are purely preferential, that is, various features may be omitted, modified or replaced by their equivalents without deviating from the scope of this invention, which is defined in the attached claims.

### DESCRIPTION OF THE DRAWINGS

For a better understanding of the invention, a page of plans is attached, showing the following

FIG. 1.

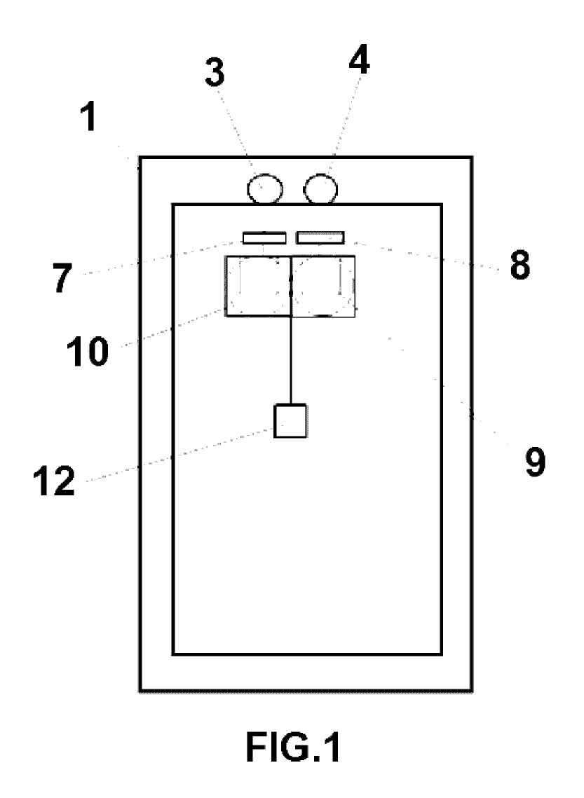

A diagram of the inner part of the elements of the invention, inside the mobile device.

FIG. 2.

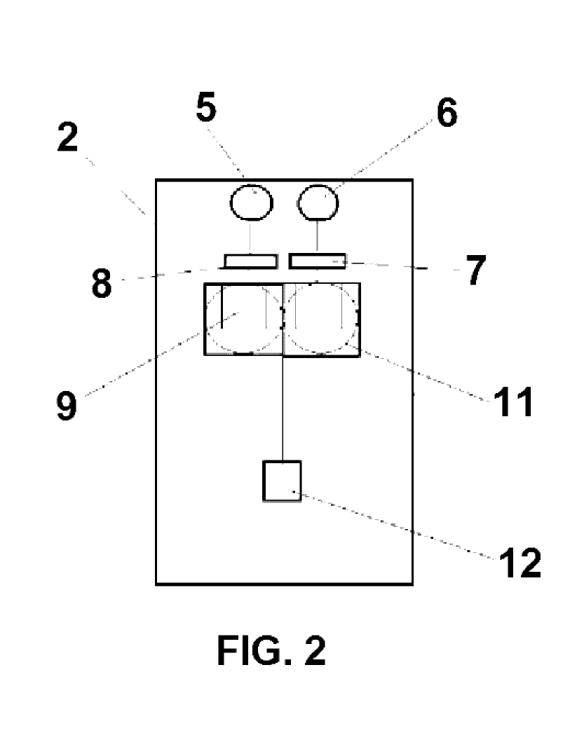

A diagram of the inner rear part of the elements of the invention, inside the mobile device.

In those figures, a single reference is used to identify identical elements, among them the following:
(1).—the front face of the device,
(2).—the rear face of the device,
(3).—camera No. 1,
(4).—camera No. 2,
(5).—camera No. 3,
(6).—camera No. 4,
(7).—the interface for creating the left-eye 360°×360° image,
(8).—the interface for creating the right-eye 360°×360° image,
(9).—stereoscope,
(10).—left-eye stereoscope lenses,
(11).—right-eye stereoscope lenses,
(12).—the screen visualisation interface.

### A PREFERENTIAL EMBODIMENT OF THE INVENTION

The invention, refers to portable videotelephones able to make and reproduce 360°×360° stereoscopic images and videos using two front cameras and another two at the back, located two-by-two on both faces of the device.

A preferential embodiment of the invention comprises at least the following elements:

Two photo/video cameras (3) and (4), fitted on the front (1) of the mobile device on the same horizontal plane.

Two photo/video cameras (5) and (6), fitted on the rear (2) of the mobile device on the same horizontal plane.

Said cameras (3), (4), (5) and (6) are each fitted with integrated lenses with an angular vision of 180°×180° or more.

The separation between the visual axes of both front and rear cameras will be between 0.5 mm and 1 mm.

Cameras (3) and (6) are connected to a synchronised recording and 360×360 image creation interface (7).

Cameras (4) and (5) are connected a synchronised 360×360 image creation interface ( ).

The device has in turn a stereoscope (9) to which interfaces (7) and (8) are connected, so that the lenses (10) of the stereoscope (9) assist the user's left-eye image while the stereoscope (9) lenses (11) assist the user's right-eye image.

The device also has an interface (12) for on-screen display of images.

Other interfaces may be included to increase the unit's flexibility, for example, an RS232 interface 58 to transmit and receive data in RS232 format.

Depending on the frequency of the updating used and the number of pixels employed in the images, the transmitted video image data received by the videotelephone may have to be compressed for their transfer via a low-data-speed radiocommunication channel such as those at present available in known radiocommunication cellular networks.

Video data can be compressed using the MPEG-4 standard. As an alternative, captured video images can be compressed in some other appropriate format, to transmit the data obtained through the mobile communications system.

It must be understood that the forms of implementation described above are purely preferential, that is, various features may be omitted, modified or replaced by their equivalents without deviating from the scope of this invention, defined in the attached claims.

1. A MOBILE DEVICE WITH 4 CAMERAS TO TAKE 360°×360° STEREOSCOPIC IMAGES AND VIDEOS particularly applicable to portable videotelephones able to make and reproduce 360°×360° stereoscopic images and videos, characterised essentially because said mobile device comprises the following:
Two photo/video cameras (3) and (4), fitted on the front (1) of the mobile device on the same horizontal plane.
Two photo/video cameras (5) and (6), fitted on the rear (2) of the mobile device on the same horizontal plane.
Said cameras (3), (4), (5) and (6) are each fitted with integrated lenses with an angular vision of 180°×180° or more.
The separation between the visual axes of both front and rear cameras will be between 0.5 mm and 1 mm.
Cameras (3) and (6) are connected to a synchronised recording and 360×360 image creation interface (7).
Cameras (4) and (5) are connected to a synchronised 360×360 image creation, interface ( ).
The device has in turn a stereoscope to which interfaces (7) and (8) are connected, so that the lenses (10) of the stereoscope (9) assist the user's left-eye image while stereoscope (9) lenses (11) assist the user's right-eye image.
The device also has an interface (12) for on-screen display of images.

2. A MOBILE DEVICE WITH 4 CAMERAS TO TAKE 360°×360° STEREOSCOPIC IMAGES AND VIDEOS particularly referred to portable videotelephones able to make and reproduce 360°×360° stereoscopic images and videos according to claim 1, characterised because other interfaces can be incorporated to enhance the unit's flexibility.

3. A MOBILE DEVICE WITH 4 CAMERAS TO TAKE 360°×360° STEREOSCOPIC IMAGES AND VIDEOS particularly referred to portable videotelephones able to make and reproduce 360°×360° stereoscopic images and videos according to previous claims characterised because, depending on the frequency of the updating and the number of pixels used in the images, the transmitted video image data received by the videotelephone may have to be compressed for their transfer via a low-data-speed radiocommunication channel.

4. A MOBILE DEVICE WITH 4 CAMERAS TO TAKE 360°×360° STEREOSCOPIC IMAGES AND VIDEOS particularly referred to portable videotelephones able to make and reproduce 360°×360° stereoscopic images and videos according to the previous claims, characterised because the video data can be compressed using an appropriate format to transmit the data obtained through the mobile communications system.
